(19) United States
(12) Patent Application Publication
(10) Pub. No.: US 2024/0186669 A1
(43) Pub. Date: Jun. 6, 2024

(54) PHASE SHIFTER, PHASE CONVERSION UNIT, AND PHASE CONVERSION METHOD

(71) Applicant: GIGALANE CO., LTD., Hwaseong-si Gyeonggi-do (KR)

(72) Inventors: Jae Jun LEE, Hwaseong-si, Gyeonggi-do (KR); Dae Ho KIM, Hwaseong-si, Gyeonggi-do (KR); Eun Kuk PARK; Hee Seok JUNG, Hwaseong-si, Gyeonggi-do (KR)

(21) Appl. No.: 18/554,215

(22) PCT Filed: Jun. 9, 2022
(86) PCT No.: PCT/KR22/08145

§ 371 Date: Oct. 6, 2023

(30) Foreign Application Priority Data
Jul. 8, 2021 (KR) 10-2021-0089757
Mar. 22, 2022 (KR) 10-2022-0035662

(51) Int. Cl. H01P 1/18

(52) U.S. Cl. CPC H01P 1/18

(57) ABSTRACT

The present invention relates to a phase conversion unit comprising: a first circuit board having a plurality of first circuit patterns; a plurality of second circuit boards each having a second circuit pattern, a partial area of which overlaps and is connected to one among the plurality of the first circuit patterns; a plurality of movement members for pressing the plurality of second circuit boards toward the first circuit board, moving the second circuit boards in a first direction to change the length by which the first circuit patterns and the second circuit pattern overlap each other, and thereby converting a phase through the changed length; and a housing disposed on the first circuit board and receiving the plurality of second circuit boards and the plurality of movement members.

### TECHNICAL FIELD

The present invention relates to a phase shifter, a phase conversion unit, and a phase conversion method.

### BACKGROUND ART

Recently, as a newly expanded fifth generation (5G) service is introduced in mobile communication systems, multiple-input multiple-output (MIMO) antenna technology is emerging.

In general, a beamforming technique is applied to the MIMO antenna technology in the 5G service. In such a beamforming technique, a phase shifter changes steering angles of beams radiated from antennas. In addition, the phase shifter includes a plurality of phase conversion units connected to a plurality of antennas to shift a phase of a signal transmitted to each antenna.

Meanwhile, base station equipment for providing the 5G service includes 64 antennas, and the number of phase conversion units of the phase shifter also corresponds to 64. For example, a hybrid beamforming technique (2 sub-array type) using two antennas connected to one transceiver may have 32 phase conversion units.

As described above, when the number of phase conversion units increases, there is a problem in that phases converted through a plurality of phase conversion units are not synchronized.

The background technology of the invention has been prepared to facilitate the understanding of the present invention. It should not be construed as an admission that details described in the background technology of the invention are present as the related art.

### DETAILED DESCRIPTION OF THE INVENTION

### Technical Problem

The present invention is directed to providing a phase shifter, a phase conversion unit, and a phase conversion method, which can synchronize phases converted by a plurality of phase conversion units.

Objects of the present invention are not limited to the above-described object, and other objects that are not mentioned will be able to be clearly understood by those skilled in the art from the following description.

### Technical Solution

A phase conversion unit according to an embodiment of the present invention includes a first circuit board having a plurality of first circuit patterns, a plurality of second circuit boards having a second circuit pattern of which a partial region overlaps and is connected to any one of the plurality of first circuit patterns, a plurality of movable members configured to convert phases through changed lengths by pressing the plurality of second circuit boards toward the first circuit board and moving the second circuit board in a first direction to change overlapping lengths between the first circuit patterns and the second circuit pattern, and a housing disposed on the first circuit board to accommodate the plurality of second circuit boards and the plurality of movable members.

A plurality of accommodating portions each for accommodating one of the plurality of movable members may be formed in the housing, and a partition wall may be provided between the plurality of accommodating portions.

The housing may be coupled to the first circuit board through a coupling member inserted into a hole passing through the partition wall.

Each of the plurality of movable members may include a first movable portion on which the second circuit board is disposed and a second movable portion extending from the first movable portion, may be formed in an elastic structure, and may press the second circuit board in a direction in which the first circuit board is positioned so that the second circuit pattern is connected to the first circuit patterns.

The first movable portion may be accommodated in the housing, may have side surfaces in contact with inner walls of the housing, and have one or more slits, into which an outer surface is drawn, formed therein, and thus have an elastic force against the inner walls of the housing.

The slit may be formed in the first direction, and contact portions having a length corresponding to all or part of the length of the slit and in contact with the inner walls of the housing may be formed on the side surfaces of the first movable portion.

Each of the plurality of movable members may further include a support portion protruding from an upper surface of the first movable portion, and the support portion may be supported by the housing.

Each of the plurality of movable members may further include one or more clamping members formed on the second movable portion and protruding in a rake shape, and the clamping member may be coupled by being caught on the second circuit board to mount the second circuit board on the movable member.

Each of the plurality of movable members may further include an elastic member disposed between the second circuit board and the first movable portion, and a plurality of protrusions having a shape in which an end portion splits into two may be formed on the elastic member.

Each of the plurality of movable members may further include an elastic member disposed between the second circuit board and the first movable portion, and a plurality of pressing protrusions may be formed on a lower surface of the first movable portion.

Each of the plurality of movable members may further include an elastic member having a plurality of pairs of cantilever shapes, and an end portion of the cantilever shape may be supported by the housing or the second circuit board.

The elastic member may be formed in a plate shape made of a metal material and installed on the first movable portion.

A phase conversion unit according to an embodiment of the present invention includes a first circuit board having a first circuit pattern, a second circuit board having a second circuit pattern of which a partial region overlaps and is connected to the first circuit pattern, a movable member configured to convert phases through a changed length by pressing the second circuit board toward the first circuit board and moving the second circuit board in a first direction to change an overlapping length between the first circuit pattern and the second circuit pattern, and a housing disposed on the first circuit board and configured to accommodate the first circuit pattern and the second circuit pattern, wherein the movable member is accommodated in the housing, has side surfaces in contact with inner walls of the housing, and has one or more slits, into which an outer surface is drawn, formed therein, and thus has an elastic force against the inner walls of the housing.

A phase conversion unit according to an embodiment of the present invention includes a first circuit board having a first circuit pattern, a second circuit board having a second circuit pattern of which a partial region overlaps and is connected to the first circuit pattern, a movable member configured to convert phases through a changed length by pressing the second circuit board toward the first circuit board and moving the second circuit board in a first direction to change an overlapping length between the first circuit pattern and the second circuit pattern, and a housing disposed on the first circuit board and configured to accommodate the first circuit pattern and the second circuit pattern, wherein the movable member includes a first movable portion on which the second circuit board is disposed, a second movable portion extending from the first movable portion, and one or more clamping members formed on the second movable portion and protruding in a rake shape, and the clamping member is coupled by being caught on the second circuit board to mount the second circuit board on the movable member.

Other embodiment specifics are included in the detailed description and accompanying drawings.

### Advantageous Effects

According to the present invention, since a phase shifter includes a plurality of phase conversion units on a support frame and the plurality of phase conversion units are simultaneously operated by an operation unit and a driving unit connected thereto, it is possible to equally convert all of a plurality of phases.

Various and beneficial advantages and effects of the present invention are not limited to the above-described contents and will more easily understood in the process of describing specific embodiments of the present invention.

### BRIEF DESCRIPTION OF DRAWINGS

FIG. 1 is a top view illustrating a phase shifter according to one embodiment of the present invention.

FIG. 2 is an exploded perspective view in which the phase conversion unit according to one embodiment of the present invention is sequentially disassembled for each component.

FIG. 3 is a perspective view illustrating a driving unit according to one embodiment of the present invention.

FIG. 4 is a schematic diagram for describing a method of changing overlapping lengths of circuit patterns in the phase conversion unit according to one embodiment of the present invention.

FIG. 5 is a perspective view illustrating a guide bar of an operation unit according to one embodiment of the present invention.

FIG. 6 is an enlarged cross-sectional view illustrating region A illustrated in FIG. 1.

FIG. 7 is a perspective view illustrating the phase conversion unit according to one embodiment of the present invention.

FIGS. 8 and 9 are perspective views for describing the structures of elastic members according to various embodiments of the present invention.

FIG. 10 is an enlarged perspective view illustrating region B illustrated in FIG. 1.

FIG. 11 is a block diagram for describing an operating method of the phase shifter according to one embodiment of the present invention.

FIG. 12 is a view illustrating a phase shifter according to another embodiment of the present invention.

FIG. 13 is a view illustrating a phase conversion unit installed in the phase shifter according to another embodiment of the present invention.

FIG. 14 is a view schematically illustrating an inside of a housing of the phase conversion unit installed in the phase shifter according to another embodiment of the present invention.

FIG. 15 is a view illustrating a movable member accommodated inside the phase conversion unit installed in the phase shifter according to another embodiment of the present invention.

FIGS. 16, 18, 21, 24, 27, 30, 33, and 36 are exploded perspective views in which various phase conversion units installed in the phase shifter according to another embodiment of the present invention are sequentially disassembled for each component.

FIGS. 17, 19, 22, 25, 28, 31, 34, and 37 are bottom perspective views illustrating movable members of various phase conversion units installed in the phase shifter according to another embodiment of the present invention.

FIG. 20 is a cross-sectional view of the phase conversion unit of FIG. 18 taken in a second direction.

FIG. 23 is a cross-sectional view of the phase conversion unit of FIG. 21 taken in a first direction.

FIG. 26 is a cross-sectional view of the phase conversion unit of FIG. 24 taken in the first direction.

FIG. 29 is a cross-sectional view of the phase conversion unit of FIG. 27 taken in the first direction.

FIG. 32 is a bottom perspective view illustrating a state in which the movable member and a second circuit board are coupled in the phase conversion unit of FIG. 30.

FIG. 35 is a cross-sectional view of the phase conversion unit of FIG. 33 taken in the first direction.

FIG. 38 is a cross-sectional view of the phase conversion unit of FIG. 36 taken in the first direction.

### MODES OF THE INVENTION

Hereinafter, embodiments of the present invention will be described in detail with reference to the accompanying drawings so that those skilled in the art to which the present invention pertains may easily carry out the present invention.

The present invention may be implemented in various different forms and is not limited to the embodiments described herein.

For reference, a phase conversion unit defined in the present invention may be generally understood as being a phase shifter.

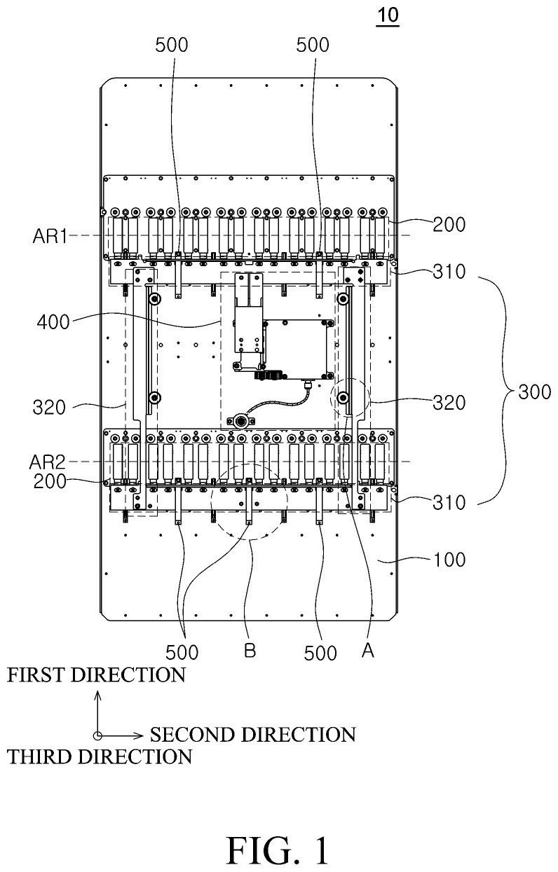

FIG. 1 is a top view illustrating a phase shifter according to one embodiment of the present invention.

As illustrated in FIG. 1, a phase shifter 10 according to the present invention is a device for changing the steering angles of beams radiated from antennas and may shift phases of signals transmitted to the antennas through a plurality of phase conversion units 200.

To this end, the phase shifter 10 may include a support frame 100, the phase conversion unit 200, an operation unit 300, and a driving unit 400.

The plurality of phase conversion units 200 may be disposed on the support frame 100. The support frame 100 may be formed as a flat frame and made of a hard material capable of supporting the plurality of phase conversion units 200, for example, a metal material such as aluminum. The support frame 100 may be formed in a quadrangular shape in which the plurality of phase conversion units 200 are disposed in the form of an array. However, the material and shape of the support frame 100 are not limited to the above-described example.

The plurality of phase conversion units 200 may be disposed on the support frame 100 in the form of a plurality of arrays. Specifically, the plurality of phase conversion units 200 may be disposed on the support frame 100 in the form of arrays spaced apart from each other in a second direction, and the arrays of the phase conversion units 200 may be disposed as a plurality of arrays spaced apart from each other in a first direction.

In FIG. 1, a plurality of phase conversion units 200 in which a pair of arrays AR1 and AR2 are disposed vertically based on the center of the support frame 100, that is, at both sides of the support frame 100 in the second direction, are illustrated, but the present invention is not limited thereto. For example, three or more arrays of the plurality of phase conversion units 200 may be disposed on the support frame 100.

The operation unit 300 may be connected to the plurality of phase conversion units 200 to synchronize phases converted through the plurality of phase conversion units 200. Specifically, the operation unit 300 may synchronize the phases by changing the entire length of transmission lines connected inside the plurality of phase conversion units 200, that is, signal lines connected to antennas, and a more detailed description thereof will be made below.

The driving unit 400 may drive the operation unit 300. Specifically, the driving unit 400 may drive the operation unit 300 through structural interlocking with the operation unit 300.

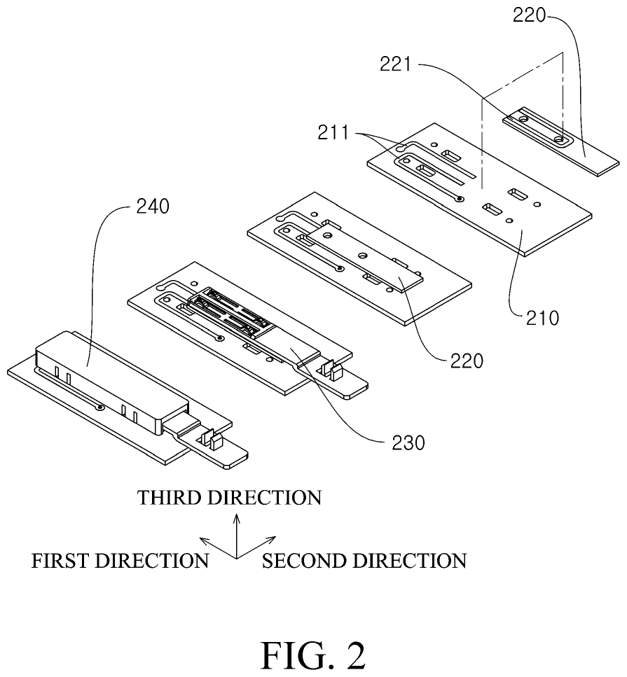

FIG. 2 is an exploded perspective view in which the phase conversion unit according to one embodiment of the present invention is sequentially disassembled for each component. For reference, FIG. 2 is a view illustrating that more components are disassembled toward the right.

As illustrated in FIG. 2, each of the plurality of phase conversion units 200 may include a first circuit board 210, a second circuit board 220, a movable member 230, and a housing 240.

According to the embodiment, the first circuit board 210 and the second circuit board 220 are printed circuit boards (PCBs), in which the first circuit board 210 may have a first circuit pattern 211, and the second circuit board 220 may have a second circuit pattern 221. In this case, the first circuit pattern 211 and the second circuit pattern 221 may constitute circuit patterns as parts of transmission lines that transmit signals to antennas.

A surface of the second circuit board 220, which has the second circuit pattern 221, may be disposed to face a surface of the first circuit board 210, which has the first circuit pattern 211, so that the second circuit pattern 221 may overlap and be connected to the first circuit pattern 211. Therefore, a partial region of the second circuit pattern 221 may overlap and be connected to the first circuit pattern 211.

An overlapping length between the second circuit pattern 221 and the first circuit pattern 211 may be changed according to the driving of the operation unit 300. Specifically, the second circuit board 220 having the second circuit pattern 221 may be disposed on one surface of the movable member 230, and when the movable member 230 connected to the operation unit 300 moves in the first direction, the overlapping length between the first circuit pattern 211 and the second circuit pattern 221, that is, the length of the circuit pattern, may be changed. For example, since the second circuit board 220 moves in the first direction together with the movable member 230 while the first circuit board 210 is stationary, the lengths of the circuit patterns may be changed as much as the second circuit board 220 moves in the first direction.

The housing 240 may be disposed on the first circuit board 210 to accommodate the first circuit pattern 211 and the second circuit pattern 221. According to the embodiment, the movable member 230 and the housing 240 may be made of a non-conductive material to prevent the distortion of signals transmitted through the first circuit pattern 211 and the second circuit pattern 221.

Meanwhile, in FIG. 2, although it is illustrated that the first circuit pattern 211 is formed on the first circuit board 210, the first circuit pattern 211 may be formed on the housing 240. For example, a lower surface may be formed on the housing 240 instead of the first circuit board 210, and the first circuit pattern 211 may be formed on the lower surface of the housing 240, that is, a surface in contact with one surface of the movable member 230.

In addition, although it is illustrated that the second circuit pattern 221 is formed on the second circuit board 220, the second circuit pattern 221 may be formed on the movable member 230. In other words, since one or more of the first circuit board 210 and the second circuit board 220 may be omitted from the phase conversion unit 200, it is possible to reduce the number of man-hours for manufacturing the phase conversion unit 200.

Referring back to FIG. 1, the operation unit 300 may be connected to the plurality of phase conversion units 200 to synchronize a plurality of phases. Specifically, the operation unit 300 may include a plurality of operation bars 310 connecting one sides of the plurality of phase conversion units 200 disposed in the form of arrays, and one or more guide bars 320 connecting the plurality of operation bars 310. According to the embodiment, the plurality of operation bars 310 may be disposed to correspond to the number of arrays of the plurality of phase conversion units 200. For example, when a pair of arrays AR1 and AR2 are disposed, a pair of operation bars 310 may be disposed.

The plurality of operation bars 310 may be connected to the one or more guide bars 320 so that the plurality of operation bars 310 may simultaneously move in the first direction.

The one or more guide bars 320 may be disposed in the form of a pair of guide bars 320 connecting both sides of the plurality of operation bars 310. When the pair of guide bars 320 connect both sides of the operation bars 310, the movement of the plurality of phase conversion units 200 may be corrected by the guide bars 320 connected to the other side of the operation bar 310 even when the movement of the guide bars 320 connected to one side of the operation bar 310 is distorted.

According to the embodiment, although it is illustrated that the pair of guide bars 320 are connected to both sides of the pair of operation bars 310 in FIG. 1, if necessary, three or more operation bars 310 may be connected to the pair of guide bars 320. For example, the pair of a first guide bar 320 and a second guide bar 320 connected to both sides of the first operation bars 310 may be connected to both sides of a second operation bar 310 and a third operation bar 310, respectively, so that the first operation bar 310, the second operation bar 310, and the third operation bar 310 may simultaneously move in the first direction through the first guide bar 320 and the second guide bar 320.

As described above, the plurality of operation bars 310 may simultaneously move in the first direction through the one or more guide bars 320. In addition, while the plurality of operation bars 310 move in the first direction through the plurality of guide bars 320, the plurality of operation bars 310 may move stably and simultaneously without the distortion of any one side.

In addition, as the plurality of operation bars 310 simultaneously move, the operation units 300 may equally convert, that is, synchronize a plurality of phases. The driving unit 400 may be disposed on the support frame 100 to drive the operation unit 300. Specifically, as the driving unit 400 is connected to at least one of the plurality of operation bars 310, the driving unit 400 may provide a driving force sufficient for moving the plurality of operation bars 310 in the first direction. For example, the driving unit 400 may be an actuator.

So far, the phase shifter 10 according to one embodiment of the present invention has been described. According to the present invention, since the phase shifter 10 includes the plurality of phase conversion units 200 on the support frame 100 and the plurality of phase conversion units 200 are simultaneously operated by the operation unit 300 and the driving unit 400 connected thereto, it is possible to synchronize all of the plurality of phases equally.

Hereinafter, a structure of the driving unit 400 for operating the plurality of phase conversion units 200 will be described.

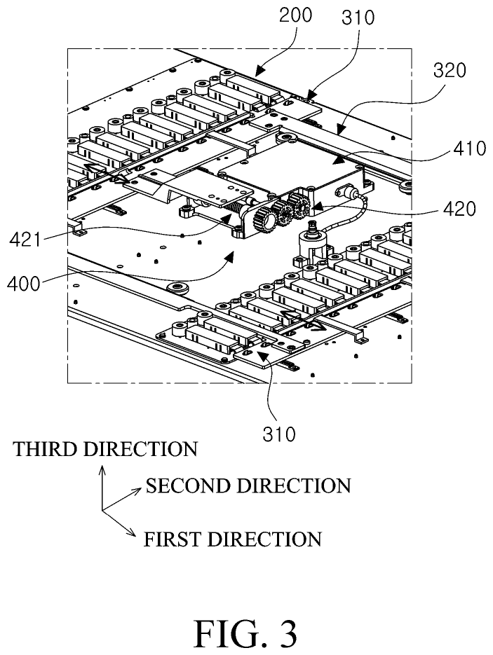

FIG. 3 is a perspective view illustrating a driving unit according to one embodiment of the present invention.

As illustrated in FIG. 3, the driving unit 400 may include a motor 410 and a plurality of gears 420. The motor 410 may have a rotational shaft, and the plurality of gears 420 may be rotated in conjunction with the rotational shaft of the motor 410. For example, a first rotating gear among the plurality of gears 420 may be rotated in conjunction with the rotational shaft of the motor 410, and a gear interlocked with the first rotating gear may be rotated.

In addition, the rotation of the plurality of gears 420 may be interlocked with the movement of the plurality of operation bars 310. Therefore, the plurality of gears 420 may equally move the plurality of operation bars 310 and the movable members 230 of the plurality of phase conversion units 200 connected thereto in the first direction through a driving force transmitted from the motor 410.

For example, a finally rotating gear among the plurality of gears 420 and any one of the plurality of operation bars 310 may be connected with a ball screw 421 so that the rotational motion of the gear may be converted into linear motion of the plurality of operation bars 310.

Meanwhile, since a plurality of gears are formed, a rotational speed of the motor 410 may be decreased according to a gear ratio, and the moving speed of the plurality of operation bars 310 may be decreased to be prevented from being faster than necessary.

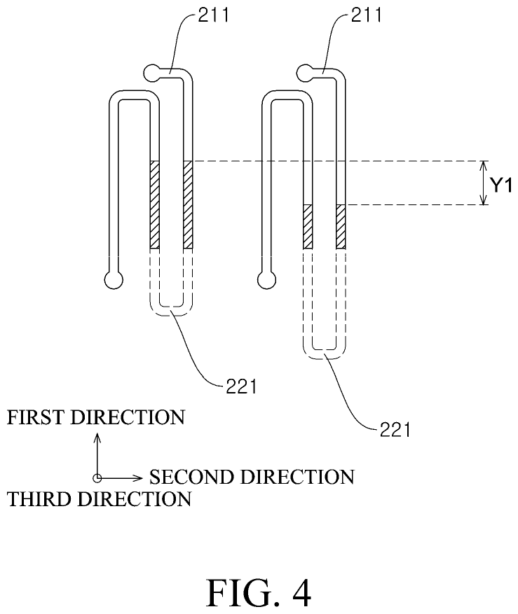

FIG. 4 is a schematic diagram for describing a method of changing overlapping lengths of circuit patterns in the phase conversion unit according to one embodiment of the present invention.

As illustrated in FIG. 4, the first circuit patterns 211 and the second circuit patterns 221 in the plurality of phase conversion units 200 may overlap in regions indicated by hatched lines. As the overlapping length increases, the length of the circuit pattern may decrease, and as the overlapping length decreases, the length of the circuit pattern may increase.

When the motor 410 and the plurality of gears 420 are driven, the overlapping lengths of the first circuit patterns 211 and the second circuit patterns 221 may be changed by the plurality of operation bars 310, and phases may be converted through a length difference value Y1 of the circuit pattern.

In other words, a driving range of the plurality of operation bars 310 may correspond to the overlapping length of the first circuit pattern 211 and the second circuit pattern 221. For example, the driving range of the plurality of operation bars 310 may be in a range of 0 mm to 14 mm, and the overlapping length of the circuit patterns may be in a range of 0 mm to 14 mm.

So far, the driving unit 400 according to one embodiment of the present invention has been described. Hereinafter, a structure of the operation unit 300 operated by the driving force generated by the driving unit 400 will be described.

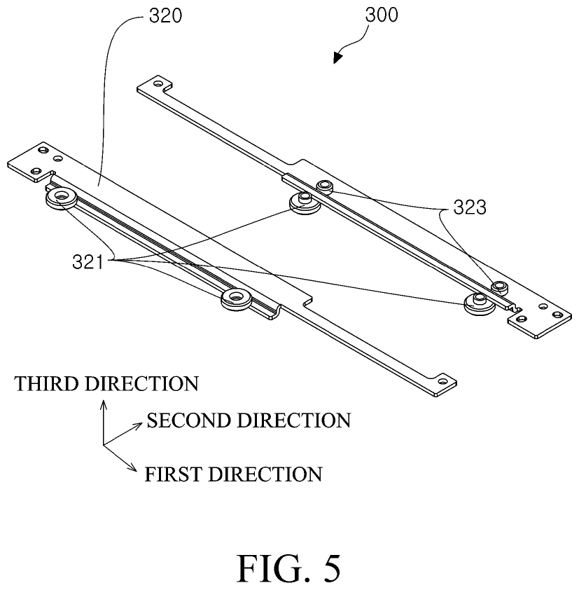

FIG. 5 is a perspective view illustrating a guide bar of an operation unit according to one embodiment of the present invention. For reference, the left drawing of FIG. 5 is a view of the guide bar viewed from above, and the right drawing of FIG. 5 is a view of the guide bar viewed from below.

As illustrated in FIG. 5, the guide bar 320 may be moved by the driving unit 400 in the first direction, and for smooth movement in the first direction, a first guide roller 321 and a second guide roller 323 may be further included in one region.

In addition, each of the guide bars 320 may include two first guide rollers 321 and two second guide rollers 323, and the number of first guide rollers 321 and second guide rollers 323 may be one or three or more as needed.

Meanwhile, the movement of the guide bar 320 in the second direction and the third direction may be restricted by a coupling structure of the first guide roller 321 and the second guide roller 323, and the guide bar 320 may stably move in the first direction.

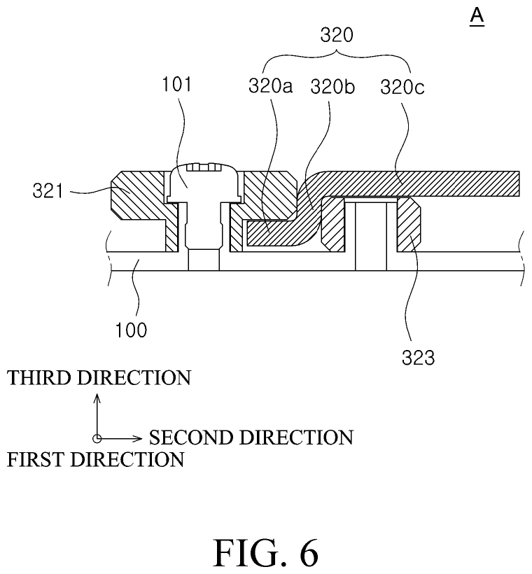

FIG. 6 is an enlarged cross-sectional view illustrating region A illustrated in FIG. 1.

As illustrated in FIG. 6, the guide bar 320 may have a shape in which a cross section viewed from the front of the phase shifter 10 (in the first direction) is bent, and the guide bar 320 may be divided into a first guide portion 320a, a second guide portion 320b, and a third guide portion 320c based on the bent portion.

The first guide portion 320a may be disposed to face the support frame 100, and the second guide portion 320b may be bent from the first guide portion 320a to extend in a direction away from the support frame 100. The third guide portion 320c may be bent from the second guide portion 320b to extend parallel to the first guide portion 320a.

The first guide roller 321 may be disposed above the first guide portion 320a. Specifically, a lower surface of the first guide roller 321 may be in contact with the first guide portion 320a, and a side surface thereof may be in contact with one side surface of the second guide portion 320b.

The second guide roller 323 may be disposed under the third guide portion 320c. Specifically, an upper surface of the second guide roller 323 may be in contact with the third guide portion 320c, and a side surface thereof may be in contact with the other side surface of the second guide portion 320b.

The first guide roller 321 and the second guide roller 323 may restrict the movement of the guide bar 320 in a second direction perpendicular to the first direction on the flat surface of the support frame 100 and restrict the movement of the guide bar 320 in a third direction perpendicular to the first direction and the second direction on the same plane. Specifically, the movement of the second guide portion 320b to one side (right side where the second guide roller 323 is disposed) in the second direction may be restricted by the first guide roller 321, and the movement of the second guide portion 320b to the other side (left side where the first guide roller 321 is disposed) in the second direction may be restricted by the second guide roller 321. In addition, the movement of the first guide portion 320a to one side (upper side where the first guide roller 321 is disposed) in the third direction may be restricted by the first guide roller 321, and the movement of the third guide portion 320c to the other side (lower side where the second guide roller 323 is disposed) in the third direction may be restricted by the second guide roller 323.

As described above, although the movement of the guide bar 320 in the second direction and the third direction may be restricted through the first guide roller 321 seated at one side of the guide bar 320 and the second guide roller 323 seated at the other side thereof, the guide bar 320 may smoothly move in the first direction.

In addition, a rotational shaft positioned on the flat surface of the support frame 100 may be inserted into the first guide roller 321, and the first guide roller 321 may be fixed to the rotational shaft through a fixing member 101. In addition, a rotational shaft positioned on the flat surface of the support frame 100 may be inserted into the second guide roller 323. Although not illustrated in the drawing, the second guide roller 323 may also be fixed to the rotational shaft through a separate fixing member (not illustrated) like the first guide roller 321.

As the first guide roller 321 and the second guide roller 323 rotate about rotational shafts disposed parallel to each other, the first guide roller 321 and the second guide roller 323 may correspondingly restrict the movement of the guide bar 320 in the second direction and the third direction, and thus more smoothly restrict the movement of the guide bar 320 in the second direction and the third direction.

In addition, the first guide roller 321 and the second guide roller 323 may be made of a material capable of minimizing damage caused by friction. According to the embodiment, the first guide roller 321 and the second guide roller 323 may be made of a material resistant to wear, such as heat-resistant plastic, and specifically made of any one of polyphenylene sulfide (PPS), a liquid crystal polymer (LCP), and polytetrafluoroethylene (PPTE).

As described above, since the first guide roller 321 and the second guide roller 323 are made of a material resistant to wear, it is possible to improve the durability of the phase shifter 10 without causing a reduction in the performance of restricting the movement of the guide bar 320 due to wear of the roller while the guide bar 310 repeatedly moves.

So far, the structure of the operation unit 300 according to one embodiment of the present invention has been described. Hereinafter, a structure of the phase conversion unit 200 for changing the overlapping length of the first circuit pattern 211 and the second circuit pattern 221 according to the driving of the operation unit 300 will be described.

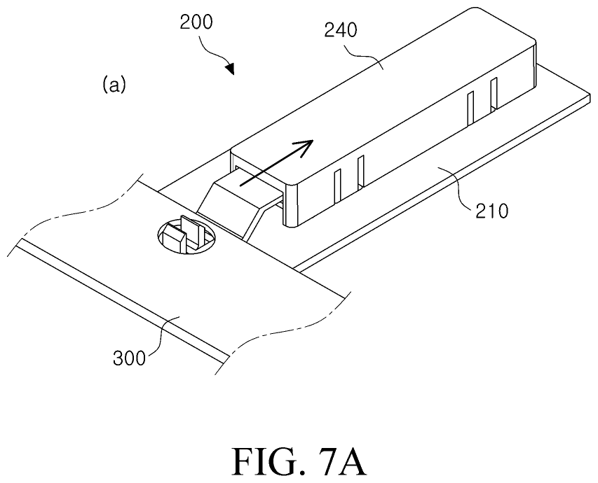

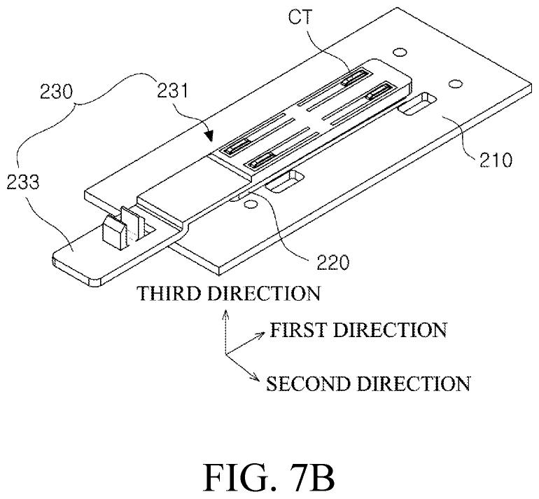

FIG. 7 is a perspective view illustrating the phase conversion unit according to one embodiment of the present invention. For reference, the upper drawing of FIG. 7 is a view including a housing, and the lower drawing of FIG. 7 is a view excluding the housing.

As illustrated in FIG. 7, each of the plurality of phase conversion units 200 may further include the movable member 230 for changing the overlapping length of the first circuit pattern 211 and the second circuit pattern 221. Specifically, referring to FIG. 7B, the movable member 230 may have a shape in which a cross section viewed from the side (in the second direction) of the phase shifter 10 is bent and include a first movable portion 231 and a second movable portion 233 partitioned based on the bent shape.

The second circuit board 220 may be disposed on the first movable portion 231, and the second movable portion 233 may extend from the first movable portion 231 and be fixedly coupled to the operation unit 300. For example, a protruding part of the second movable portion 233 may be fixedly coupled by being inserted into a hole of the operation unit 300. In this case, one end of the protruding part may have a hook shape for preventing the protruding part from being separated after being inserted into the hole of the operation unit 300.

The movable member 230 may be moved by the operation unit 300 in the first direction together with the second circuit board 220 to change the overlapping length of the first circuit pattern 211 and the second circuit pattern 221.

According to the embodiment, the second circuit board 220 disposed on the movable member 230 may be in a state of being spaced a minute distance from the first circuit board 210 in the third direction, and the second circuit pattern 221 may be in close contact with the first circuit pattern 211 through an elastic force of the movable member 230. Specifically, the movable member 230 may be formed in an elastic structure that presses the second circuit board 220 in a direction in which the first circuit board 210 is positioned through the elastic force so that the second circuit pattern 221 may come into close contact with the first circuit pattern 211. For example, the elastic structure may be a structure in which a shape or material has an elastic force.

First, a structure in which the shape of the movable member 230 has the elastic force will be described.

As illustrated in FIG. 7, the first movable portion 231 may have a cantilever shape CT with free ends. Specifically, while the movable member 230 moves in the first direction, the free ends of the cantilever shape CT provided on the first movable portion 231 may come into contact with the inner surface of the housing 240 to obtain an elastic force. The first movable portion 231 obtaining the elastic force may press the second circuit board 220, and the second circuit pattern 221 of the pressed second circuit board 220 may come into in close contact with the first circuit pattern 211. In this case, the first movable portion 231 may have an elastic force that maintains the close contact between the first circuit pattern 211 and the second circuit pattern 221 and does not press the second circuit board 220 more than necessary.

The movable member 230 may be made of a plastic-based material so that the first movable portion 231 may easily have the cantilever shape CT.

In FIG. 7, although it is illustrated that the free ends of the cantilever shape CT provided on the first movable portion 231 are in contact with the inner surface of the housing 240 to obtain the elastic force, the present invention is not limited thereto. For example, the free ends of the cantilever shape CT provided on the first movable portion 231 may be in contact with the second circuit board 220 to obtain an elastic force.

As described above, by forming the shape of the movable member 230 in a structure having an elastic force, the close contact between the first circuit board 210 and the second circuit board 220 is maintained, and it is possible to prevent the circuit patterns from being damaged by not pressing more than necessary.

Next, a structure in which the material of the movable member 230 has an elastic force will be described.

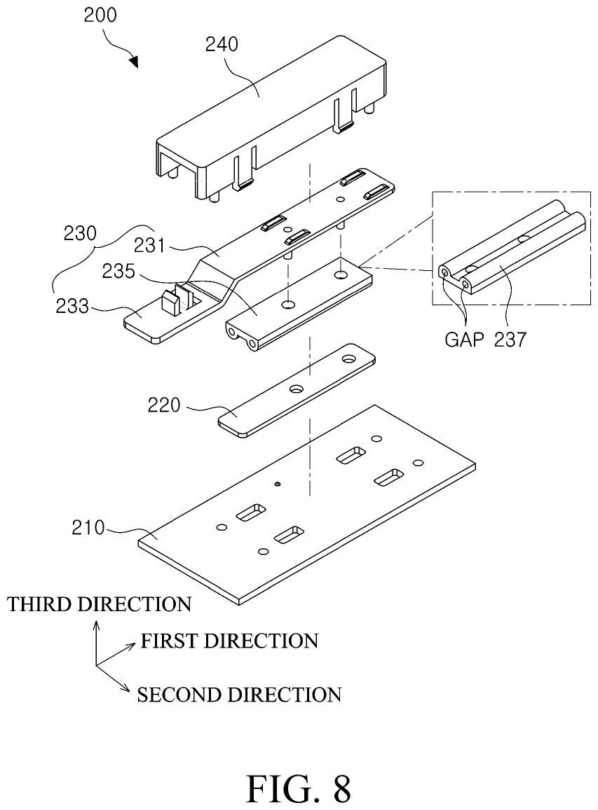

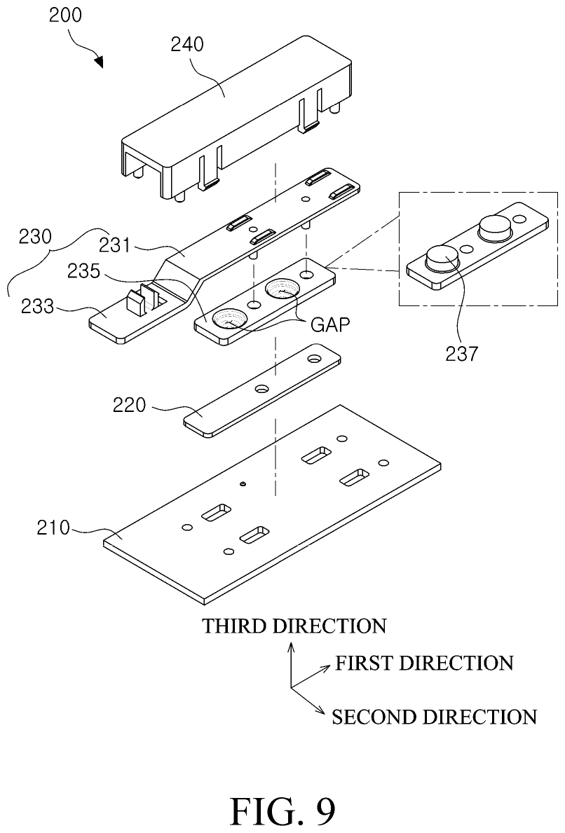

FIGS. 8 and 9 are perspective views for describing the structures of elastic members according to various embodiments of the present invention.

As illustrated in FIG. 8, the movable member 230 may further include an elastic member 235 for providing an elastic force.

The elastic member 235 may be disposed between the second circuit board 220 and the first movable portion 231, and thus may press the second circuit board 220 in a direction in which the first circuit board 210 is positioned. For example, the elastic member 235 may be made of an elastic material such as rubber or silicon.

Although not illustrated in the drawings, a plurality of through holes may be formed in the elastic member 235 to improve the mobility of the second circuit board 220 by decreasing the elastic force of the elastic member 235.

As illustrated in FIGS. 8 and 9, the elastic member 235 may further include protrusions 237.

The protrusions 237 may be disposed on at least one surface of the elastic member 235 in contact with the first movable portion 231 or the second circuit board 220. For example, the protrusions 237 may be disposed on one surface of the elastic member 235 in contact with the first movable portion 231 or disposed on both surfaces of the elastic member 235 to be in contact with the first movable portion 231 and the second circuit board 220.

When the protrusions 237 are disposed on the elastic member 235, a pressing force may be partially concentrated through the protrusions 237 to press the second circuit board 220 instead of entirely pressing the second circuit board 220 through the surface of the elastic member 235, thereby making the pressing easier.

According to the embodiment, by forming predetermined empty spaces GAP inside the protrusions 237 in the first direction, it is possible to facilitate the pressing and prevent an excessive pressing force from being applied to the second circuit board 220.

As illustrated in FIG. 9, the protrusion 237 may have a predetermined empty space GAP in an internal region.

When the elastic member 235 is made of an elastic material, the movement of the second circuit board 220 may be hindered when the pressing force of the second circuit board 220 toward the first circuit board 210 becomes larger than necessary. Therefore, it is possible to decrease the pressing force by forming the protrusions 237 on the elastic member 235 and forming the predetermined empty spaces GAP in the internal regions of the protrusions 237. In this case, as the second circuit board 220 presses the first circuit board 210 through the protrusions 237, the empty spaces GAP of the protrusions 237 may be compressed. In other words, the empty spaces GAP may be crushed by being pressed between the second circuit board 220 and the movable member 230.

As described above, the predetermined empty spaces GAP formed in the internal regions of the protrusions 237 may decrease the pressing force, thereby maintaining the close contact and improving the movement of the second circuit board 220.

So far, the phase conversion unit 200 and the internal components according to one embodiment of the present invention have been described. The above-described shape and material of the phase conversion unit 200 are not limited to the above-described example.

Hereinafter, a structure for improving the durability of the phase shifter 10 in which the plurality of phase conversion units are disposed will be described.

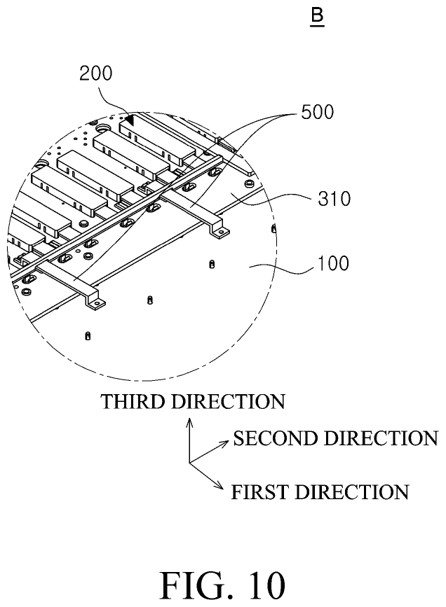

FIG. 10 is an enlarged perspective view illustrating region B illustrated in FIG. 1.

As illustrated in FIG. 10, the phase shifter 10 may further include a fixing unit 500.

The fixing unit 500 may be formed in an arch shape in which both sides are fixed to the support frame 100, and an opening may be formed between both sides fixed to the support frame 100.

One or more among the plurality of operation bars 310 may pass through the opening formed between the support frame 100 and the fixing unit 500, and the movement of the corresponding operation bar 310 in the third direction perpendicular to the first direction and the second direction may be restricted.

As described above, by restricting the movement of the operation bar 310 in the third direction through the fixing unit 500, the operation bar 310 may maintain a stable state without being lifted in the third direction while the operation bar 310 moves in the first direction.

According to the embodiment, although it is illustrated that the fixing unit 500 is disposed on each of the plurality of operation bars 310 in FIG. 1, if necessary, the fixing unit 500 may not be disposed on the operation bar 310 among the plurality of operation bars 310, which is directly connected to the driving unit 400. For example, the fixing unit 500 may be disposed on the operation bar 310 whose operation is not directly interlocked with the driving unit 400 to restrict only the movement of the corresponding operation bar 310. This is because the driving unit 400, instead of the fixing unit 500, may restrict the movement of the operation bar 310 in the third direction.

Hereinafter, a series of methods for converting the phase of the phase shifter 10 will be described.

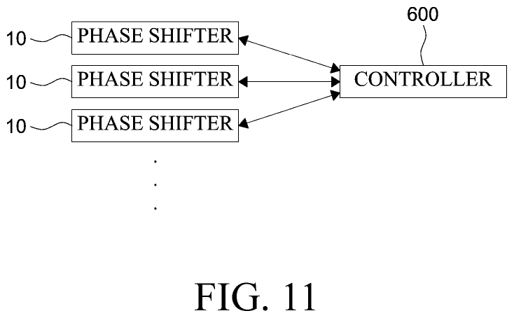

FIG. 11 is a block diagram for describing an operating method of the phase shifter according to one embodiment of the present invention.

The phase shifter 10 may include the support frame 100, the plurality of phase conversion units 200, the operation unit 300, and the driving unit 400, and since the components are the same as those of the phase shifter 10 illustrated in FIGS. 1 to 10, a detailed description thereof will be omitted.

As illustrated in FIG. 11, the phase shifter 10 may further include a controller 600 for controlling the operation of the phase shifter 10. Specifically, the controller 600 may provide operation commands, such as electrical signals, for operating the plurality of phase conversion units 200 to the driving unit 400, and these operation commands may be implemented in a computer readable storage medium in which commands executable by a processor are recorded.

According to the embodiment, the controller 600 may store attribute values of the motor 410 and the plurality of gears 420 of the driving unit 400 to control the operation of the driving unit 400. For example, the controller 20 may store the number of gear teeth of the plurality of gears 420, a rotational ratio of the plurality of gears 420, etc.

According to the embodiment, as illustrated in FIG. 11, the controller 600 may control the operation of a plurality of phase shifters 10, or the operation may be controlled through a controller 600 individually connected to the plurality of phase shifters 10.

According to the embodiment, the controller 600 may convert the phase of the phase shifter 10 based on a value input from a manager.

First, the controller 600 may acquire an input value corresponding to a phase to be converted. As one example of the input value, the controller 600 may acquire a phase conversion value of the phase shifter 10 as the input value. Here, the phase conversion value may be in a range of 0° to 12° tilt, but may not be limited thereto.

As another example of the input value, the controller 600 may acquire an overlapping length change value of the circuit patterns in the phase conversion unit 200 or a driving range value of the operation unit 300 as the input value. Here, the overlapping length value of the circuit patterns and the driving range value of the operation unit 300 may be in a range of 0 mm to 14 mm, but may not be limited thereto.

Next, after acquiring the input value, the controller 600 may generate a result value for equally converting the phases through the plurality of phase conversion units 200 using the input value and a reference value pre-stored in the controller 20. Specifically, the reference value may include a calculation formula or comparison data. For example, the calculation formula may be an arithmetic operation for generating a result value according to an input value, and the comparison data may be a table in which a plurality of input values and result values according to the input values are pre-calculated and listed. In other words, since the result values according to the input values are already derived in the pre-stored comparison data, the controller 600 may match the result values based on the input values.

As one example of the reference value, the reference value stored in the controller 600 may include a relative ratio calculation formula or comparison data generated based on a conversion range of the input value and the driving range of the operation unit 300. Here, the conversion range of the input value may be the phase conversion range (e.g., in a range of 0° to 12° tilt) of the phase conversion unit 200, and the driving range of the operation unit 300 may be a change range (e.g., in a range of 0 mm to 14 mm) of the overlapping length of the circuit patterns. More specifically, the relative ratio calculation formula may be a formula for determining whether the operation unit 300 should be moved Y mm in order to convert the phase by X°. For example, when the controller 600 inputs a tilt angle of the beam (direction of the beam tilted by 6°) into the relative ratio calculation formula in which the reference value is reflected, the controller 600 may obtain a movement length value (7 mm) of the operation unit 300 as an output. In other words, the controller 600 may calculate an output value in which the length of the circuit pattern increases by 7 mm through the relative ratio calculation formula.

As another example of the reference value, the reference value stored in the controller 600 may include a gear ratio calculation formula or comparison data generated based on the plurality of gears 420. Here, the gear ratio calculation formula is data that may be obtained from the number of teeth of the gears 420, and the controller 600 may store the gear ratio calculation formula (e.g., the number of teeth of a driven gear/the number of teeth of a driving gear) of the plurality of gears 420 and input the gear ratio calculation formula in the calculation process of generating a result value for an input value.

Next, the controller 600 may convert each phase by driving the operation unit 300 and the driving unit 400 based on the result value after generating the result value. For example, the result value may be an operation command controlling a rotational amount of the driving unit 400 for controlling a change in length of the circuit pattern, that is, the movement length of the operation unit 300.

According to the embodiment, the controller 600 may control the operation unit 300 to be driven through the driving unit 400 based on the generated result value and control a driving speed depending on whether a load is present. Specifically, the result value may include consecutive values for driving the operation unit 300 at a low speed or a high speed through the driving unit 400, and the operation unit 300 may be driven at a low speed or a high speed through the driving unit 400 based on the consecutive values.

The controller 600 may drive the operation unit 300 at a low speed through the driving unit 400 in a preset range according to the result value, and when a load is not applied to the driving unit 400 while the driving unit 400 is driven in the preset range upon driving at a low speed, the controller 20 may drive the operation unit 300 at a high speed through the driving unit. In this case, “load” may refer to a state in which the operation unit 300 is not driven because it is caught on an obstacle.

As described above, since the controller 20 may drive the operation unit 300 at a low speed in the preset range through the driving unit 400 and then drive the operation unit 300 at a high speed, it is possible to prevent the operation unit 300 from being damaged by an obstacle while being driven at a high speed.

In addition, the operation of the operation unit 300 and the driving unit 400 may be sequentially performed without stopping according to a change in driving speed.

Hereinafter a phase shifter according to another embodiment of the present invention will be described.

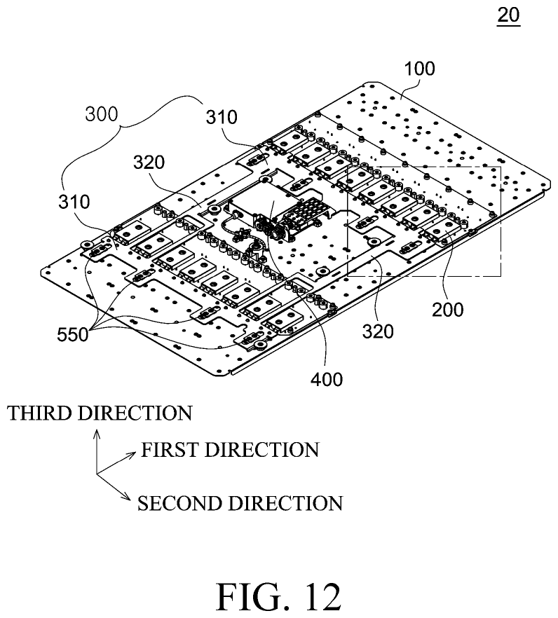

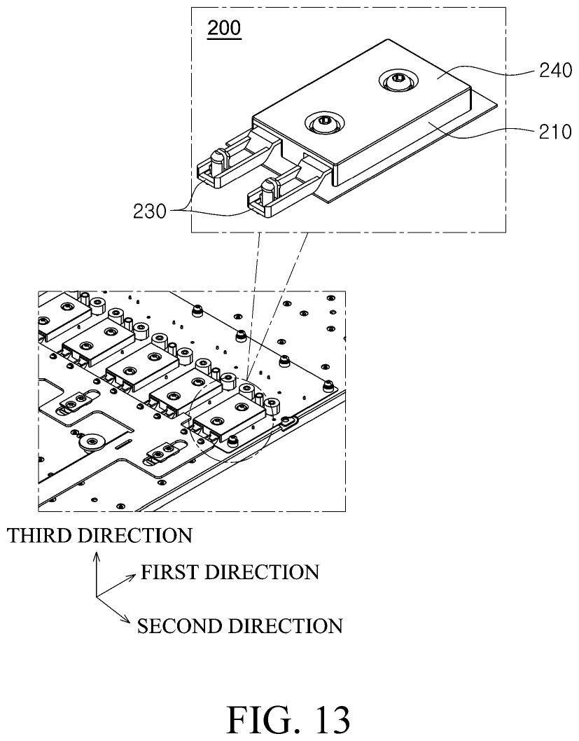

FIG. 12 is a view illustrating a phase shifter according to another embodiment of the present invention. FIG. 13 is a view illustrating a phase conversion unit installed in the phase shifter according to another embodiment of the present invention.

The phase conversion unit according to another embodiment of the present invention includes a first circuit board 210 having a plurality of first circuit patterns 211, a plurality of second circuit boards 220 having a second circuit pattern 221 of which a partial region overlaps and is connected to any one of the plurality of first circuit patterns 211, a plurality of movable members 230 for converting phases through changed lengths by pressing the plurality of second circuit boards 220 toward the first circuit board 210 and moving the second circuit boards 220 in a first direction to change overlapping lengths between the first circuit patterns 211 and the second circuit pattern 221, and a housing 240 disposed on the first circuit board 210 to accommodate the plurality of second circuit boards 220 and the plurality of movable members 230.

In other words, unlike the phase shifter according to one embodiment of the present invention including the housing 240 in which one movable member 230 for pressing one second circuit board 220 toward the first circuit board 210 is provided, in the plurality of phase conversion units 200 of the phase shifter according to another embodiment of the present invention, the plurality of movable members 230 are accommodated in pairs in the housing 240, and thus phase conversion is performed by pressing the plurality of second circuit boards 220 toward the first circuit board 210 having the plurality of first circuit patterns 211 by each of the plurality of movable members 230.

Therefore, since the phase shifter according to another embodiment of the present invention may accommodate the plurality of movable members 230 in one housing, it is possible to reduce manufacturing costs and simplify an assembly process, and the components may be compactly disposed or assembled in the phase shifter.

In the phase shifter according to another embodiment of the present invention, each of the plurality of movable members 230 may include a first movable portion 231 on which the second circuit board 220 is disposed and a second movable portion 233 extending from the first movable portion 231 and may be formed in an elastic structure to press the second circuit board 220 in a direction in which the first circuit board 210 is positioned so that the second circuit pattern 221 is connected to the first circuit patterns 211.

In addition, a protruding part of the second movable portion 233 may be fixedly coupled by being inserted into a hole of the operation unit 300. In this case, one end of the protruding part may have a hook shape for preventing the protruding part from being separated after being inserted into the hole of the operation unit 300. In other words, the phase conversion unit 200 may perform phase conversion by moving the plurality of movable members 230 together with the operation unit 300 through the protruding part.

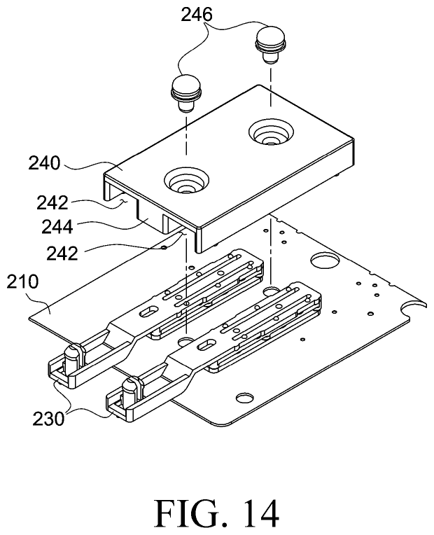

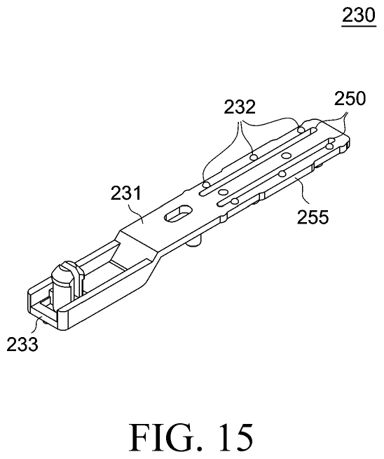

In addition, referring to FIGS. 14 and 15, a plurality of accommodating portions 242 each for accommodating one of the plurality of movable members 230 are formed in the housing 240, and a partition wall 244 may be provided between the plurality of accommodating portions 242. The housing 240 may be coupled to the first circuit board 210 through coupling members 246 inserted into holes passing through the partition wall 244.

In other words, in the movable member 230, since the second movable portion 233 moves together with the operation unit 300, the first movable portion 231 accommodated in the accommodating portion 242 of the housing 240 and partitioned by the partition wall 244 performs phase conversion.

In addition, the coupling member 246 includes a screw, a bolt, or the like, is inserted into a groove formed in an upper surface of the housing 240, and coupled to the first circuit board 210 disposed at a lower end after passing through the partition wall 244, and thus fixes the housing 240 to the first circuit board 210.

Meanwhile, the first movable portion 231 may be accommodated in the housing 240 so that side surfaces thereof are in contact with inner walls of the housing 240, and may have one or more slits 250 into which an outer surface is drawn formed therein, and thus may have an elastic force against the inner walls of the housing 240. The slit 250 may be formed in the first direction, and contact portions 255 having a length corresponding to all or part of the length of the slit 250 and protruding to be in contact with the inner walls of the housing 240 may be formed on the side surfaces of the first movable portion 231.

In other words, the slit 250 may be formed in the first direction, and thus the side surfaces of the first movable portion 231 may be drawn into the slits 250 according to a contact state with the inner walls of the housing 240 and may have an elastic force to be restored as much as the side surfaces of the first movable portion 231 are drawn into the slits 250, and thus may be supported by the inner walls of the housing 240 to restrict the movement in the second direction perpendicular to the first direction so that the first movable portion 231 may be moved in the first direction without being distorted.

In addition, since the contact portions 255 protruding outward are formed on the side surfaces of the first movable portion 231 so that the side surfaces are appropriately drawn into the slits 250 when the first movable portion 231 is in contact with the inner walls of the housing 240, the contact portions 255 are supported by the inner walls of the housing 240. Since a length of the contact portion 255 may be variously adjusted according to a protruding height and the length of the slit 250, the magnitude of the elastic force of the first movable portion 231 may be changed.

Therefore, since the movable member 230 of the phase shifter according to another embodiment of the present invention may be moved in the first direction without being distorted, the first circuit patterns and the second circuit pattern may stably overlap.

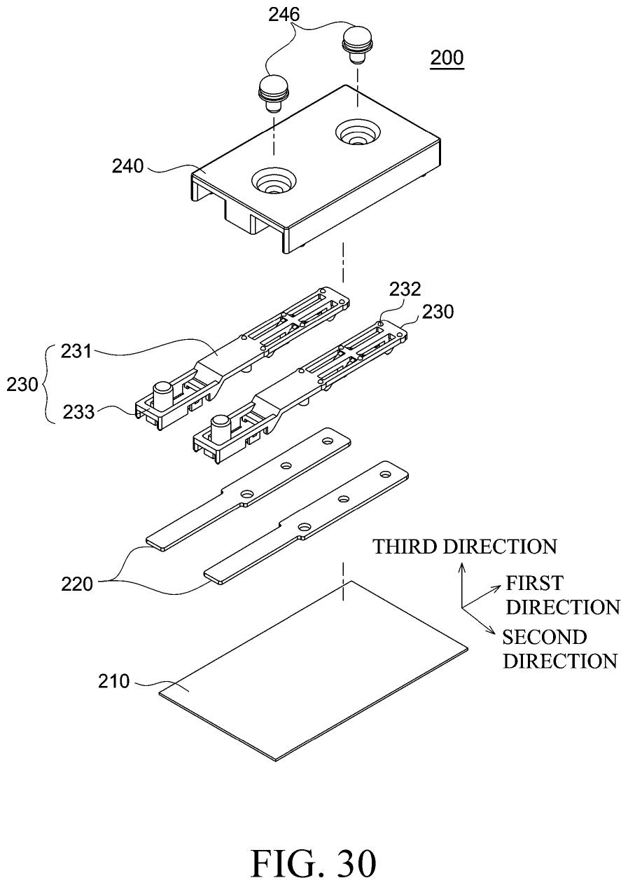

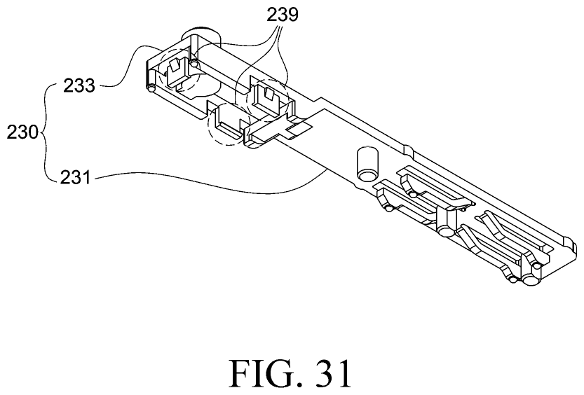

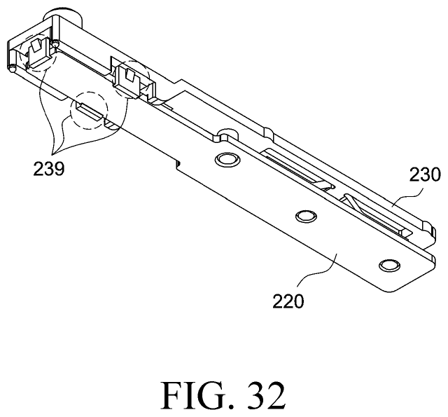

Meanwhile, FIG. 31 is a bottom perspective view illustrating the movable member of the phase conversion unit in FIG. 30, and FIG. 32 is a bottom perspective view illustrating a state in which the movable member and the second circuit board are coupled in the phase conversion unit in FIG. 30.

Referring to FIGS. 30 to 32, in the phase shifter according to various embodiments of the present invention, each of the plurality of movable members 230 may further include one or more clamping members 239 formed on the second movable portion 233 and protruding in a rake shape, and the clamping member 239 may be coupled by being caught on the second circuit board 220 to mount the second circuit board 220 on the movable member 230.

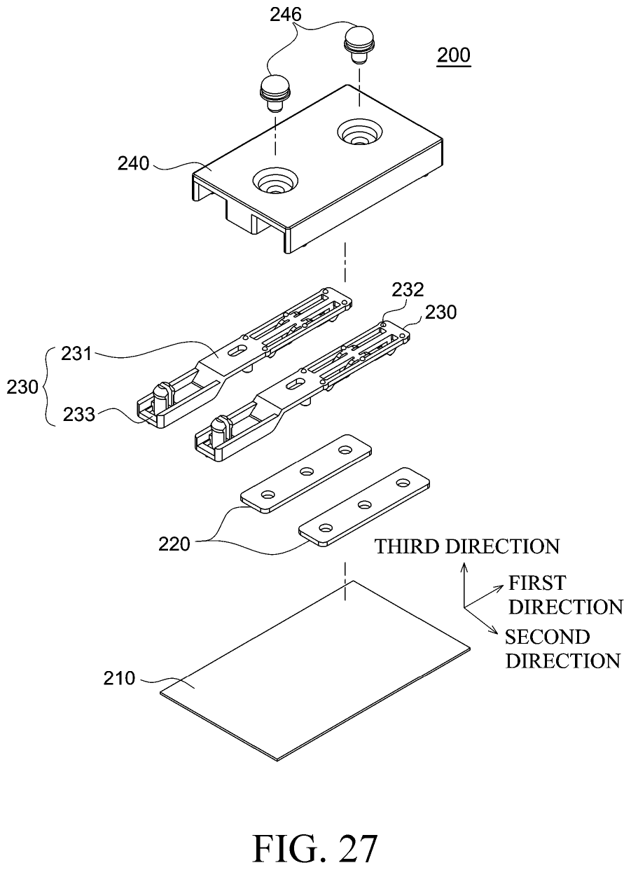

Although the movable member 230 of the phase conversion unit according to the embodiment of FIG. 30 is similar to that of the phase conversion unit 200 according to the embodiment of FIG. 27, referring to the bottom perspective views of FIGS. 31 and 32, it can be seen that the clamping member 239 having the rake shape is formed on a lower surface of the second movable portion 233. The clamping member 239 mounts an end portion of the second circuit board 220 having a shape in which one side is extended compared to other embodiments.

Therefore, in the phase conversion unit according to the embodiment of FIG. 30, each of the clamping members 239 may be coupled by being caught on the end portion of the second circuit board 220 to mount the second circuit board 220 on the clamping member 239, and thus even when a pressing force is applied to the second circuit board 220, the close contact between the movable member 230 and the second circuit board 220 may be maintained to precisely perform phase conversion without slipping.

In addition, referring to FIGS. 14 and 15, in the phase shifter according to another embodiment of the present invention, each of the plurality of movable members 230 may further include a support portion 232 protruding from an upper surface or lower surface of the first movable portion 231, and the support portion 232 may be supported by the housing 240 or the second circuit board 220. In this case, a plurality of support portions 232 spaced apart from each other may be disposed on the upper surface of the first movable portion 231 in a hemispherical shape. Therefore, the movable member 230 and the housing 240 or the movable member 230 and the second circuit board 220 may be tightly embedded in the phase conversion unit 200 without spaces therebetween.

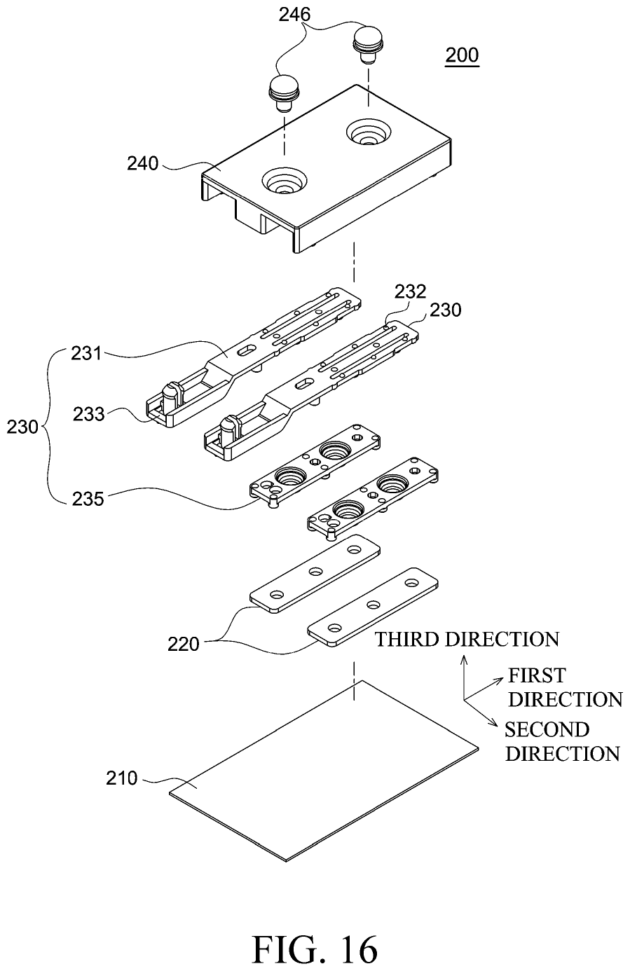

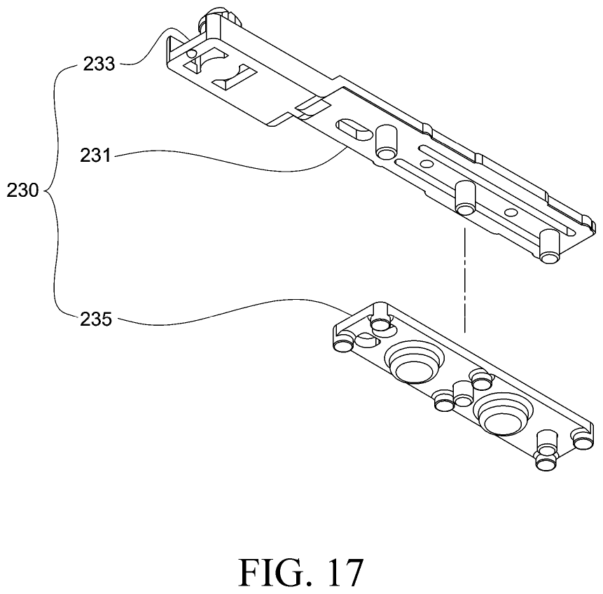

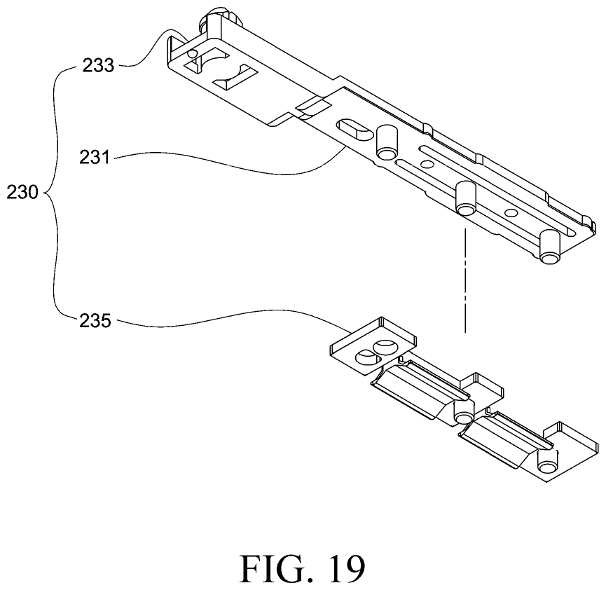

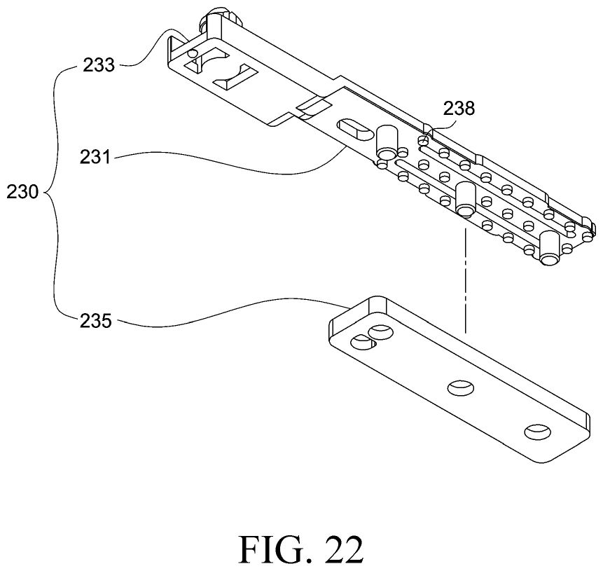

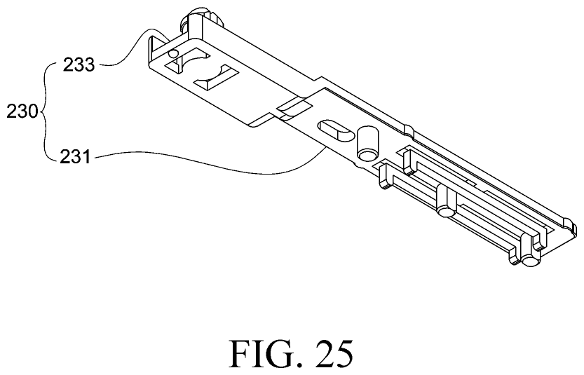

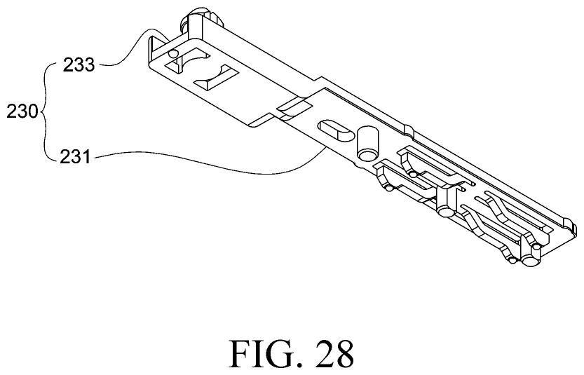

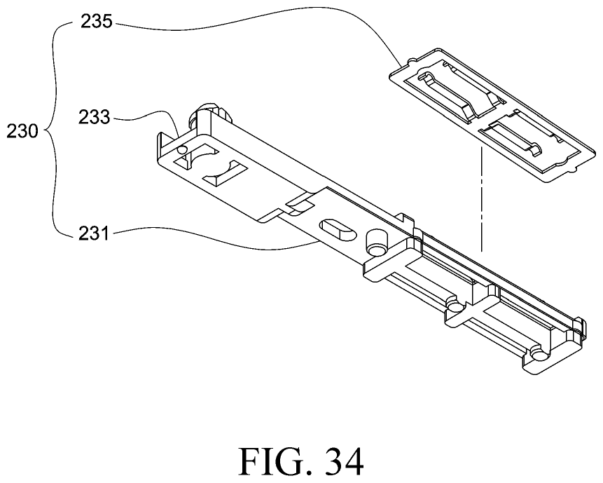

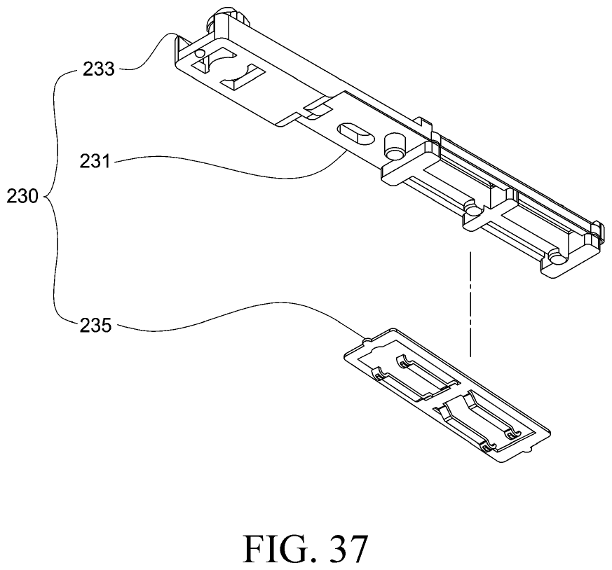

FIGS. 16, 18, 21, 24, 27, 30, 33, and 36 are exploded perspective views in which various phase conversion units installed in the phase shifter according to another embodiment of the present invention are sequentially disassembled for each component, and FIGS. 17, 19, 22, 25, 28, 31, 34, and 37 are bottom perspective views illustrating movable members of various phase conversion units installed in the phase shifter according to another embodiment of the present invention.

Referring to FIGS. 16 to 38, it can be seen that a plurality of support portions 232 spaced apart from each other are disposed on the upper surface of the first movable portion 231 in a hemispherical shape, and thus the movable member 230 and the housing 240 or the movable member 230 and the second circuit board 220 may be tightly embedded in the phase conversion unit 200 without spaces therebetween.

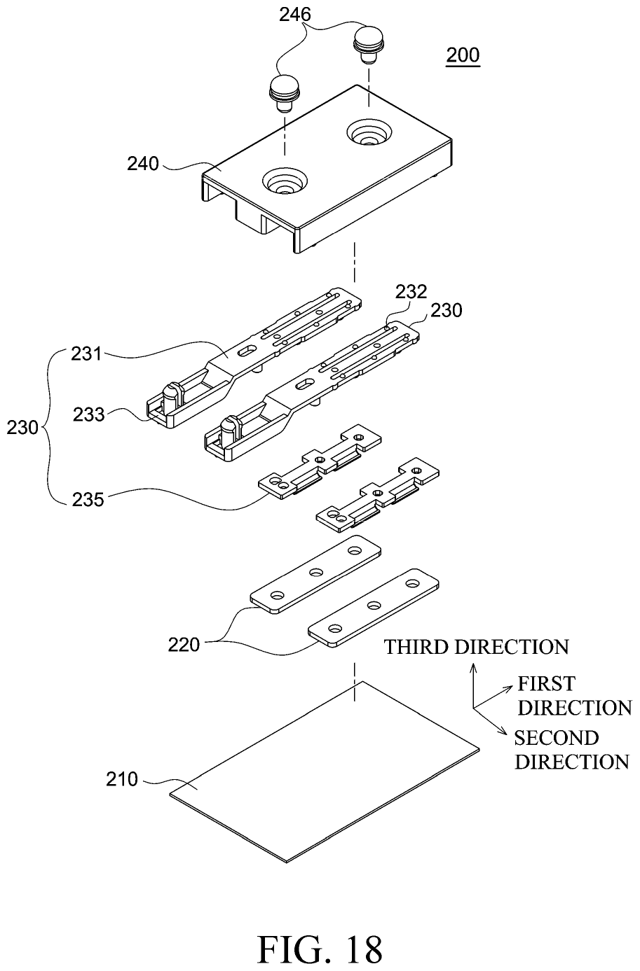

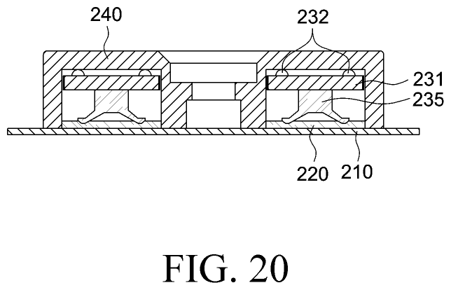

Meanwhile, FIG. 20 is a cross-sectional view of the phase conversion unit of FIG. 18 taken in a second direction. Referring to FIGS. 16 to 20, in the phase shifter according to another embodiment of the present invention, each of the plurality of movable members may further include an elastic member 235 disposed between the second circuit board 220 and the first movable portion 231, and a protrusion 237 disposed on at least one surface of the elastic member 235 to be in contact with any one of the first movable portion 231 and the second circuit board 220 may be formed on the elastic member 235. In addition, the elastic member 235 is made of rubber or silicon.

The phase conversion unit 200 according to the embodiment of FIG. 16 and the phase conversion unit 200 according to the embodiment of FIG. 18 have a similar movable member 230, but there is a difference in the elastic member 235 disposed at the lower end of the movable member 230. In the phase conversion unit 200 according to the embodiment of FIG. 16, two cylindrical protrusions 237 are provided on the elastic member 235, and when the movable member 230 presses the second circuit board 220, the protrusions 237 are compressed to transmit a pressing force to the second circuit board 220 through the restoring force thereof.

In the phase conversion unit 200 according to the embodiment of FIG. 18, two protrusions 237 are provided on the elastic member 235, and the protrusion 237 has a shape (i.e., a Y shape) in which an end portion splits into two, and when the movable member 230 presses the second circuit board 220, a width of the split portions of the protrusion 237 increases, and the protrusion 237 transmits a pressing force to the second circuit board 220 through the restoring force thereof.

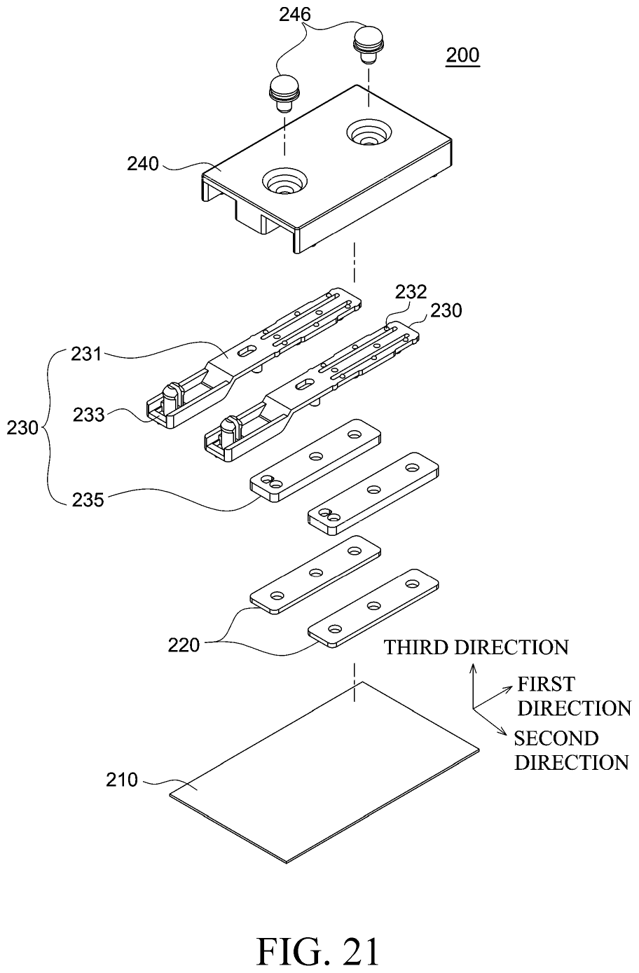

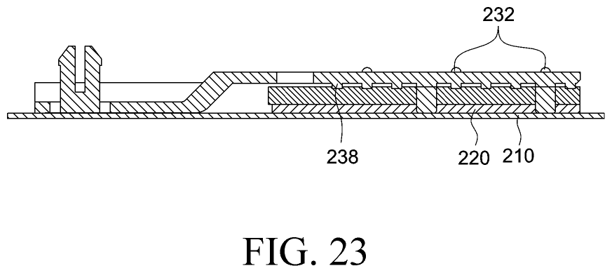

In addition, FIG. 23 is a cross-sectional view of the phase conversion unit of FIG. 21 taken in the first direction. Referring to FIGS. 21 to 23, unlike the phase conversion unit 200 according to the embodiment of FIG. 16 and the phase conversion unit 200 according to the embodiment of FIG. 18, in the phase conversion unit 200 according to the embodiment of FIG. 21 in the phase shifter according to another embodiment of the present invention, a plurality of pressing protrusions are formed on the lower surface of the first movable portion 231 of the movable member 230, and the elastic member 235 has a smooth shape in which protrusions are not formed on the upper and lower surfaces thereof and is made of rubber or silicon.

In other words, referring to FIG. 23, in the phase conversion unit 200 according to the embodiment of FIG. 21, as the pressing protrusion presses the upper surface of the elastic member 235, the smooth lower surface of the elastic member 235 comes into close contact with the second circuit board 220 to provide a pressing force to the second circuit board 220 through the elastic force of the material itself of the elastic member 235.

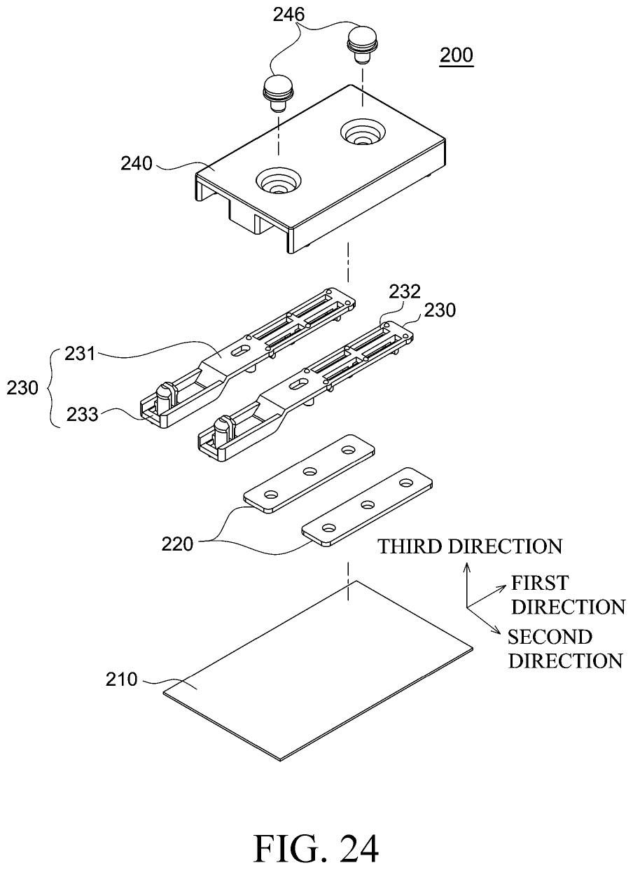

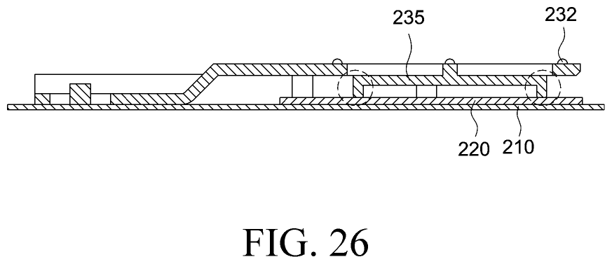

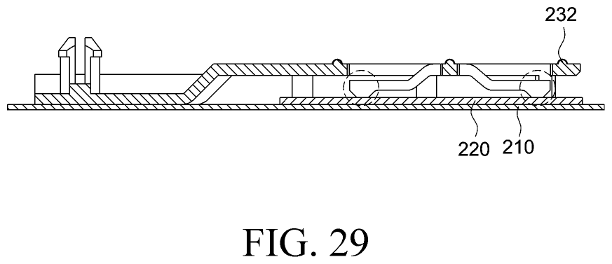

Meanwhile, FIG. 26 is a cross-sectional view of the phase conversion unit of FIG. 24 taken in the first direction, and FIG. 29 is a cross-sectional view of the phase conversion unit of FIG. 27 taken in the first direction. Referring to FIGS. 24 to 29, in the phase shifter according to another embodiment of the present invention, each of the plurality of movable members 230 may further include an elastic member 235 integrally formed with the first movable portion 231 and having one or more cantilever shapes having free ends, and an end portion of the cantilever shape of the elastic member 235 may be supported by the second circuit board 220.

Specifically, in the phase conversion unit 200 according to the embodiment of FIG. 24, each of two pairs of cantilever shapes are provided on one of the elastic members 235 in the second direction, and each pair of cantilever shapes extend in one of the first direction and a direction that is opposite to the first direction based on a central portion of the elastic member 235 and have bent end portions to be supported by the upper surface of the second circuit board 220. Each cantilever shape is bent in the third direction when the movable member 230 presses the second circuit board 220, and transmits the pressing force to the second circuit board 220 through a restoring force thereof.

Likewise, in the phase conversion unit 200 according to the embodiment of FIG. 27, each of two pairs of cantilever shapes are provided on one of the elastic members 235 in the second direction, and each pair of cantilever shapes have an initial portion extending obliquely based on the central portion of the elastic member 235 and then are bent to extend in one of the first direction and a direction that is opposite to the first direction and have end portions on which pressing protrusions protruding in a direction that is opposite to the third direction are formed, and thus the pressing protrusions are supported by the upper surface of the second circuit board 220. Likewise, each cantilever shape is bent in the third direction when the movable member 230 presses the second circuit board 220, and transmits the pressing force to the second circuit board 220 through the restoring force thereof.

In other words, in the phase conversion unit 200 according to the embodiment of FIG. 24, the two pairs of cantilever shapes of the elastic member 235 are formed to extend from the lower surface of the first movable portion 231 of the movable member 230, and in the phase conversion unit 200 according to the embodiment of FIG. 27, the two pairs of cantilever shapes of the elastic member 235 are formed to extend from side surfaces of the first movable portion 231 of the movable member 230. In this case, a groove having a length corresponding to the two pairs of cantilever shapes of the elastic member 235 may be formed at a position facing the two pairs of cantilever shapes of the elastic member 235 in the first movable portion 231 of the movable member 230 to increase an operation range of the two pairs of cantilever shapes of the elastic member 235.

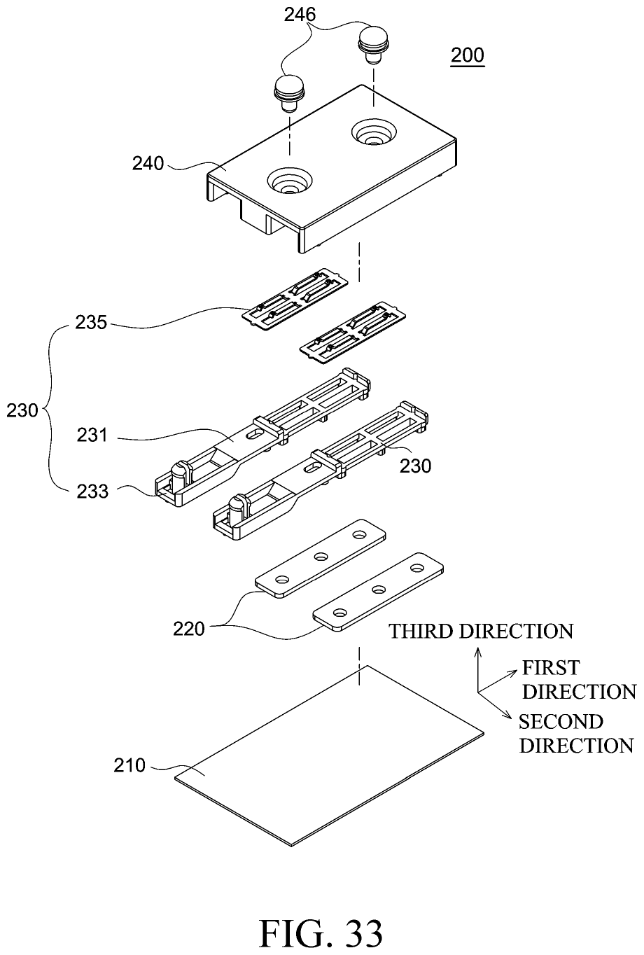

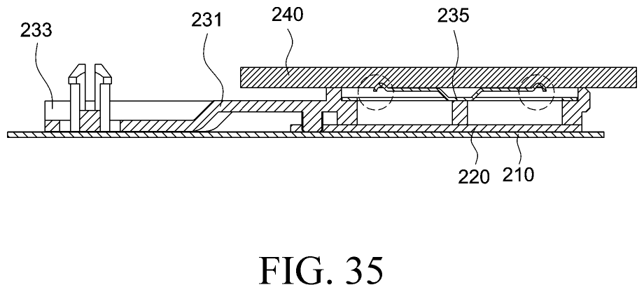

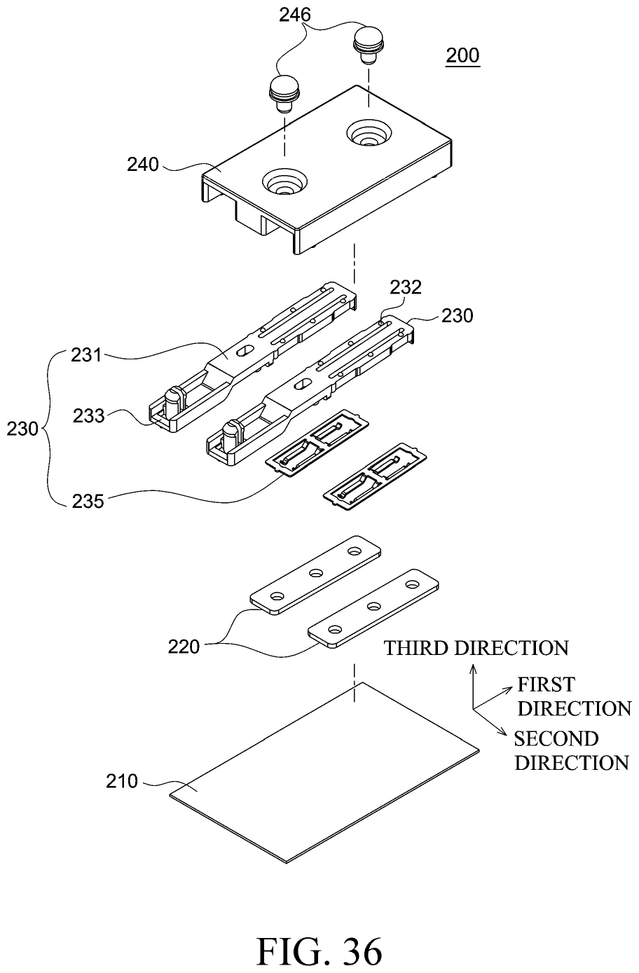

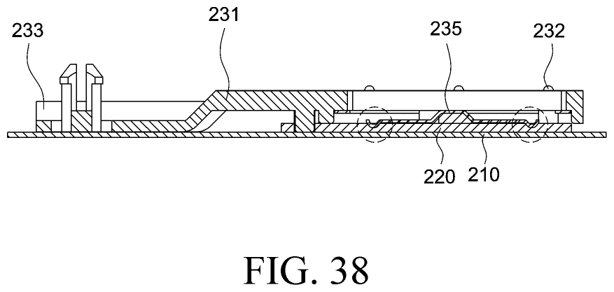

Meanwhile, FIG. 35 is a cross-sectional view of the phase conversion unit of FIG. 33 taken in the first direction. FIG. 38 is a cross-sectional view of the phase conversion unit of FIG. 36 taken in the first direction. Referring to FIGS. 33 to 38, in the phase shifters according to various embodiments of the present invention, each of the plurality of movable members 230 may further include an elastic member installed on the upper surface or lower surface of the first movable portion 231 and having one or more cantilever shapes having free ends, and an end portion of the cantilever shape of the elastic member 235 may be supported by the housing 240 or the second circuit board 220.

Specifically, in the phase conversion unit 200 according to the embodiment of FIG. 33, an elastic member 235 formed in a plate shape made of a metal material is installed on the first movable portion 231 of the movable member 230. In addition, each of two pairs of cantilever shapes is formed on one of the elastic members 235 in the second direction, and each pair of cantilever shapes have an initial portion obliquely extending based on a central portion of the elastic member 235 and then are bent to extend in one of the first direction and a direction that is opposite to the first direction and end portions thereof are bent again, and thus the bent portions are supported by an inner surface of the housing 240 of the second circuit board 220. Each cantilever shape is bent in a direction that is opposite to the third direction when the housing 240 presses the movable member 230, provides a pressing force to the first movable portion 231 through the restoring force thereof, and transmits the pressing force to the second circuit board 220 in contact with the first movable portion 231.

Like the phase conversion unit 200 according to the embodiment of FIG. 33, in the phase conversion unit 200 according to the embodiment of FIG. 36, the elastic member 235 formed in a plate shape made of a metal material is installed on the first movable portion 231 of the movable member 230. In addition, each of two pairs of cantilever shapes is formed on one of the elastic members 235 in the second direction, and each pair of cantilever shapes have an initial portion obliquely extending based on a central portion of the elastic member 235 and then are bent to extend in one of the first direction and a direction that is opposite to the first direction and end portions thereof are bent again, and thus the bent portions are supported by the second circuit board 220. Each cantilever shape is bent in the third direction when the movable member 230 presses the second circuit board 220, and transmits the pressing force to the second circuit board 220 through the restoring force thereof.

In other words, unlike the phase conversion unit 200 according to the embodiment of FIG. 33 in which the elastic member 235 is installed on the upper surface of the first movable portion 231, in the phase conversion unit 200 according to the embodiment of FIG. 36, there is a difference in that the elastic member 235 is installed on the lower surface of the first movable portion 231, the material, size, shape, and the like of the elastic member 235 are configured the same, and only installation positions are changed depending on the types of circuit boards, and thus phase conversion may be performed.

Finally, in various technical fields required for signal processing or signal phase conversion, since the phase conversion unit 200 according to various embodiments can be applied to the phase shifters according to various embodiments of the present invention, as needed, the utilization thereof is expected to be high.

Although the present invention has been described above in detail through exemplary embodiments, the present invention is not limited thereto and may be variously carried out within the scope of the claims.

1. A phase conversion unit comprising:
a first circuit board having a plurality of first circuit patterns;
a plurality of second circuit boards having a second circuit pattern of which a partial region overlaps and is connected to any one of the plurality of first circuit patterns;
a plurality of movable members configured to convert phases through changed lengths by pressing the plurality of second circuit boards toward the first circuit board and moving the second circuit board in a first direction to change overlapping lengths between the first circuit patterns and the second circuit pattern; and
a housing disposed on the first circuit board and configured to accommodate the plurality of second circuit boards and the plurality of movable members.

2. The phase conversion unit of claim 1, wherein a plurality of accommodating portions each for accommodating one of the plurality of movable members are formed in the housing, and
a partition wall is provided between the plurality of accommodating portions.

3. The phase conversion unit of claim 2, wherein the housing is coupled to the first circuit board through a coupling member inserted into a hole passing through the partition wall.

4. The phase conversion unit of claim 1, wherein each of the plurality of movable members includes a first movable portion on which the second circuit board is disposed and a second movable portion extending from the first movable portion,
is formed in an elastic structure, and
presses the second circuit board in a direction in which the first circuit board is positioned so that the second circuit pattern is connected to the first circuit patterns.

5. The phase conversion unit of claim 4, wherein the first movable portion is accommodated in the housing, has side surfaces in contact with inner walls of the housing, and has one or more slits, into which an outer surface is drawn, formed therein, and thus has an elastic force against the inner walls of the housing.

6. The phase conversion unit of claim 5, wherein the slit is formed in the first direction, and
contact portions having a length corresponding to all or part of the length of the slit and in contact with the inner walls of the housing are formed on the side surfaces of the first movable portion.

7. The phase conversion unit of claim 4, wherein each of the plurality of movable members further includes a support portion protruding from an upper surface of the first movable portion, and
the support portion is supported by the housing.

8. The phase conversion unit of claim 4, wherein each of the plurality of movable members further includes one or more clamping members formed on the second movable portion and protruding in a rake shape, and
the clamping member is coupled by being caught on the second circuit board to mount the second circuit board on the movable member.

9. The phase conversion unit of claim 4, wherein each of the plurality of movable members further includes an elastic member disposed between the second circuit board and the first movable portion, and
a plurality of protrusions having a shape in which an end portion splits into two are formed on the elastic member.

10. The phase conversion unit of claim 4, wherein each of the plurality of movable members further includes an elastic member disposed between the second circuit board and the first movable portion, and
a plurality of pressing protrusions are formed on a lower surface of the first movable portion.

11. The phase conversion unit of claim 4, wherein each of the plurality of movable members further includes an elastic member having a plurality of pairs of cantilever shapes, and
an end portion of the cantilever shape is supported by the housing or the second circuit board.

12. The phase conversion unit of claim 11, wherein the elastic member is formed in a plate shape made of a metal material and installed on the first movable portion.

13. A phase conversion unit comprising:
a first circuit board having a first circuit pattern;
a second circuit board having a second circuit pattern of which a partial region overlaps and is connected to the first circuit pattern;
a movable member configured to convert phases through a changed length by pressing the second circuit board toward the first circuit board and moving the second circuit board in a first direction to change an overlapping length between the first circuit pattern and the second circuit pattern; and
a housing disposed on the first circuit board and configured to accommodate the first circuit pattern and the second circuit pattern,
wherein the movable member is accommodated in the housing, has side surfaces in contact with inner walls of the housing, and has one or more slits, into which an outer surface is drawn, formed therein, and thus has an elastic force against the inner walls of the housing.

14. A phase conversion unit comprising:
a first circuit board having a first circuit pattern;
a second circuit board having a second circuit pattern of which a partial region overlaps and is connected to the first circuit pattern;
a movable member configured to convert phases through a changed length by pressing the second circuit board toward the first circuit board and moving the second circuit board in a first direction to change an overlapping length between the first circuit pattern and the second circuit pattern; and
a housing disposed on the first circuit board and configured to accommodate the first circuit pattern and the second circuit pattern,
wherein the movable member includes a first movable portion on which the second circuit board is disposed, a second movable portion extending from the first movable portion, and one or more clamping members formed on the second movable portion and protruding in a rake shape, and
the clamping member is coupled by being caught on the second circuit board to mount the second circuit board on the movable member.
